(19) United States
(12) Patent Application Publication
(10) Pub. No.: US 2005/0047372 A1
(43) Pub. Date: Mar. 3, 2005

(54) Seamless handover method for mobile IPv6 home agent

(76) Inventors: Masashi Yano, Kawasaki (JP); Nie Ya Ling, Beijing (CN); Masahiro Ojima, Tokyo (JP); Niu Zhisheng, Beijing (CN)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/880,643

(22) Filed: Jul. 1, 2004

(30) Foreign Application Priority Data
Jul. 1, 2003 (CN) 03145740.1

(51) Int. Cl. H04Q 7/00; H04Q 7/20

(52) U.S. Cl. 370/331; 455/436

(57) ABSTRACT

The present invention relates to a handover method of a mobile IPv6 communication network capable of reducing the handover interrupt time, the packet loss rate, and the load of the home agent. The mobile station is a single or a multimode physical access terminal, and monitors a link situation to obtain a network handover initiation. After obtaining initiation information, the mobile station sends handover information including link information of a new access router to a current access router and the current access router returns network information of the new access router, and the mobile station starts a network layer handover of the mobile IPv6 before the link layer handover. Data sent from the communication end to the mobile station is directly sent to a new care-of address of the mobile station. In order to reduce the packet loss, the new access router stores data sent to the mobile station before the mobile station and the new access router establish their connection. After the connection between the mobile station and the new access router is established, data stored in the router is transmitted to the mobile station. In order to reduce the load of the home agent, the home agent only manages the position of the mobile station and is not in charge of packet's encapsulation and forward. The establishment of the connection between the communication end and the mobile station is completed by querying the position of the mobile station from the home agent.

### CROSS-REFERENCE TO RELATED APPLICATION

The present application claims priority from Chinese patent application No. 03145740.1 filed on Jul. 1, 2003, the content of which is hereby incorporated by reference into this application.

### BACKGROUND OF THE INVENTION

This present invention relates in general to a handover method in a mobile IPv6 network. More specifically, the present invention relates to a method of performing a seamless handover through a light load mobile IPv6 home agent (HA).

Real-time data businesses occupy a more and more important position in the Internet. The Real-time multimedia businesses such as network phone, network TV, network game, and network appliances are more and more involved with human's life. At the same time, network functions of mobile terminals are enhanced. When the integrated circuit technology is developed to a certain level, anything can have functions of a mobile network.

Time requests for real-time businesses are that: audio business interrupt is less than 400 ms; and video business requires more than 25 frames per second (transmission interval is less than 40 ms). The transmission control protocol business quality is divided into three levels: 1) an acceptable low error rate and a low failure rate; 2) an acceptable error rate and unacceptable high failure rate; and 3) a unacceptable high error rate. The present invention can reduce a handover interrupt time and a packet loss rate to a level that the businesses can accept. The current Internet transmission latency is almost 0, and most of the latency comes from the network processing latency (processing time of accessing gateway, router table querying time, or packet queuing time). Therefore, the present invention needs to improve the current network protocol.

There are many methods to reduce the handover interrupt time. Since the network is divided into seven levels, the improvement can be made at every layer. (1) However, due to the complexity of the network, even though a problem is solved at a particular time, other problems may be existed during the rush hour of the network; (2) The cache technology of the network and the terminal is very important, but reasonable price and processing speed are required; and (3) the improvement on each layer has to be cooperated with each other to achieve the final object. The mobile IPv6 technology proposed by international organization IETF (Internet engineering task force) has solved the mobility issue of Internet to a certain degree. There are still serious problems in the handover interrupt and the packet loss, especially the real-time business. The problems to be solved are (1) handover interrupt time; (2) a packet loss rate; and (3) overflow of a home agent. According to the experiment of current mobile IPv6 software, the handover interrupt time and the packet loss rate also increase dramatically for the complex network and many users, which affects the communication quality. When the home agent responds to position management of many mobile stations and the encapsulation and forward of the packet, the overflow always occurs.

The handover process of the IPv6 network comprises a link layer handover and a network layer handover. The link layer handover occurs between different access points of the same subnet, and the network layer handover occurs between different access points of different subnets. The mobile IPv6 (draft-ietf-mobileip-ipv6-24.txt) research of IETF is the basic of the network layer handover of the mobile Internet. The IETF proposes concepts of hierarchy, edge pipe, and packet head binding, etc. IEEE (Institute of Electrical and Electronic Engineers) 802.11 group and 3GPP (3rd Generation Partnership Project) are now developing researches of link layer handover (WLAN, CDMA, 3G and bluetooth, etc.).

The related researches on the mobile IPv6 in the academic area are as follows. In “The Impact of IPv6 on Wireless Networks”, 3G Mobile Communication Conference Publication, No. 477, 323-329, IEEE 2001 by K P Worrall, the author has pointed out that the IETF mobile IPv6 has to be further improved. In “QoS in mobile multimedia networks”, ICCT IEEE 2000 by W. Schoneld, R. Steinmetz, and N. Berier, they have concluded that the fewer mobile pipes can increase the communication quality. The present invention applies this conclusion on the improvement of the home agent. In “Scalable Mobility and QoS Support Mechanism for IPv6-based Real-time Wireless Internet Traffic”, GLOBECOM IEEE 2001 by S. Yasukawa, J. Nishikido, and K. Hisashi, the authors have pointed out a combination of an RSVP protocol and a transit agent. In “Handoffs for Real-Time Traffic in Mobile IP Version 6 Networks”, GLOBECOM IEEE 2001 by J. Mcnair, I. Akyildiz, and M. Bender, the authors have pointed out that there can be two communication paths between a mobile station and a communication end. One is a path acquiesced by the mobile IPv6, and the other one is an RSVP path. However, the coordination between the two paths needs further researches. In “Handover Management for Mobile Nodes in IPv6 Networks”, IEEE Communication Magazine August 2002 by N. Montavont and T. Noel, the authors have tested the mobile IPv6 moving in WLAN. The result shows that the handover interrupt is most serious for multiple users.

IETF working group SeaMoby is focused on the research of mobile IPv6 seamless handover. The working group thinks the best method for implementing the seamless handover is to select a link having good communication quality from multiple links. Their research is directed to content margin transmission and backup access selection. Their work is a very large support for the present invention. The IPv6 research comprises not only the router optimization, management of MAC address, minimization of overhead, header compression, use of data buffer, communication quality, safety authentication and applications are also very important.

From the above analysis, we can find that the current technology cannot solve the existent problems (1), (2) and (3) at the same time. The light load home agent seamless handover mobile IPv6 technology proposed by the present invention is used as a technical solution for the network layer, and is suitable for high communication quality required real-time businesses, for example, multimedia and video monitoring, and especially for businesses requiring higher communication requirements, such as network games and network stock, etc.

### SUMMARY OF THE INVENTION

In order to solve the aforementioned problems, the present invention provides a new seamless handover method for mobile IPv6. The network structure is shown in FIG. 1. The present invention has the following key features.

1. The mobile station has a single or multi-mode access link. The mobile station can detect related parameters of the link layer (such as network ID of CDMA and WLAN, SNR, etc.);

2. Before the mobile station performs the link layer handover, the mobile station finishes the network layer handover and sends position update information to the home agent at the same time. The home agent further sends the position update information to the communication end of the mobile station;

3. The mobile station has a cache of network pre-care-of address (Care of Address, CoA);

4. Before the mobile station does not finish the handover, a new access router (nAR) caches data forwarded to the mobile station;

5. The home agent is only in charge of position management of the mobile station. When the communication end establishes a connection with the mobile station, the home agent first provides the current CoA of the mobile station to the communication end. The communication end uses this address to directly communicate with the mobile station.

During the handover process, the communication traffic of the mobile station is divided into two kinds: a connected communication and a potential communication. The connected communication is a communication that is going on between the mobile station and the communication end. The potential communication comes from a communication end that will communicate with the mobile station. The timely position update of the mobile station helps the potential communication. The data cache of the router helps to establish the communication. Because of the position management of the home agent, it helps end-to-end safety communication between the communication end and the mobile station. The mobile station caches the pre-CoA and helps the uncontrollable handover.

Comparison between Invention and Mobile IPv6

As shown in FIG. 12, the present invention and the mobile IPv6 are compared. It is possible to understand that the interrupt time is significantly reduced under two conditions, controllable and uncontrollable conditions.

The present invention is a new handover method for the mobile IPv6. An object is to reduce the interrupt time, to reduce the packet loss rate and to minimize the load of the home agent.

(1) Reduction of the interrupt time is implemented by pre-network layer handover.

(2) The low packet loss rate is implemented by the router cache.

(3) The load of the home agent is minimized by canceling the encapsulation function of the home agent.

### BRIEF DESCRIPTION OF THE DRAWINGS

FIG. 1 is a schematic diagram showing an example and an internal function of the network according to the present invention.

FIG. 2 is a message flow chart of a controllable handover procedure.

FIG. 3 is a structure diagram of a message definition.

FIG. 4 is a message flow chart of an uncontrollable handover procedure.

FIG. 5 is a schematic diagram of an antenna module of a mobile station.

FIG. 6 is a flow chart of determining whether a handover is to be performed or not.

FIG. 7 is a handover diagram of a mobile station.

FIG. 8 is a schematic diagram of handover time of the mobile IPv6.

FIG. 9 illustrates optimized handover timing.

FIG. 10 illustrates a router cache module.

FIG. 11 is a schematic diagram of a solution according to the present invention.

FIG. 12 shows a comparison between the present invention and the mobile IPv6.

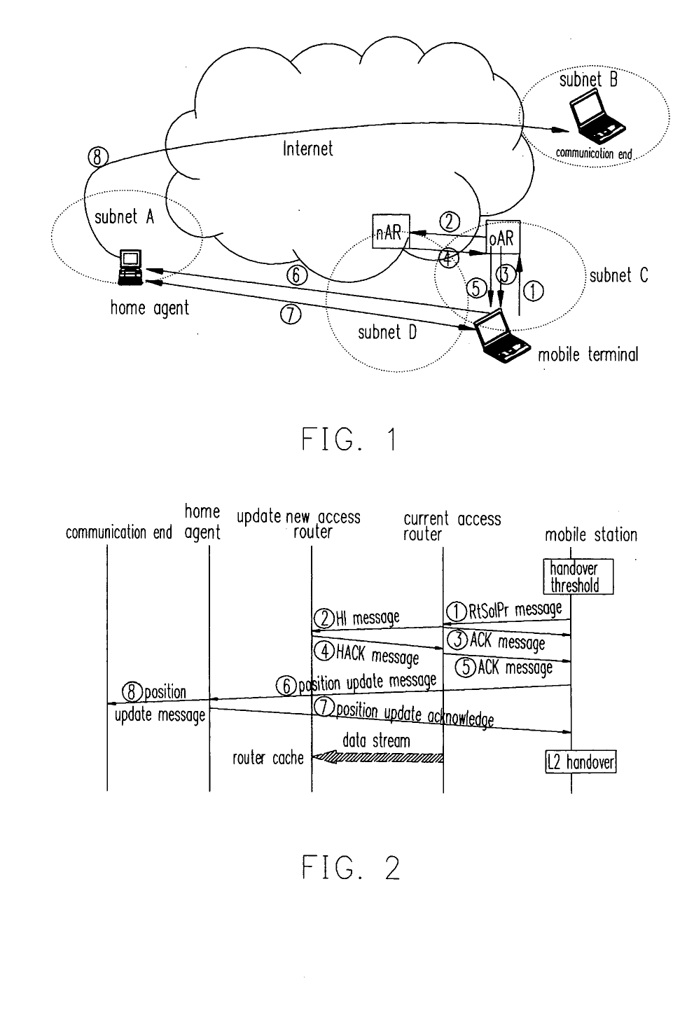

In FIGS. 2 and 4, the following abbreviations are used: “RtSolPr”: Router Solicitation for Proxy; “HI”: Handover Initiate; “HACK”: Handover Acknowledge; and “ACK”: Acknowledge.

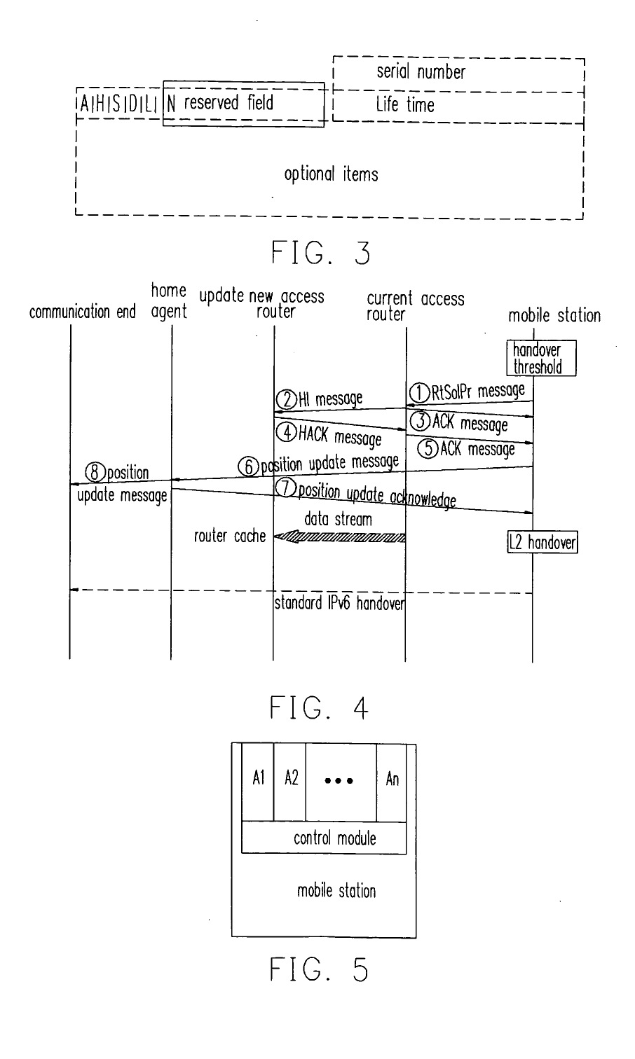

In FIG. 3, the reference symbols “A”, “H”, “S”, “D”, and “L” are information codes defined by IETF.

### DESCRIPTION OF THE PREFERRED EMBODIMENTS

1. Handover Preparation

In order to implement the fact that the mobile station finishes the mobile IPv6 network layer handover before the link layer handover is finished, the mobile station requires performing a handover preparation. Link information is monitored in time to begin the network layer handover. The entire handover time is reduced.

During the communication process, the mobile station needs to discover a network layer in time and the current router cannot be connected. In this situation, the mobile station has to establish a new CoA and handover to a connectable router. To smoothly finish the network layer handover, handover trigger information should be obtained in time from the link layer (implemented by data provided from the following [1] single or multimode wireless access and [2] link layer). The information is implemented through related protocols of the link layer and the driving software.

[1] Single or Multimode Wireless Access

The mobile station has a single or multimode wireless antennas, as shown in FIG. 5. In FIG. 5, the reference symbols “A1” to “An” show antennas (n>=2) of the mobile station. These antennas can be CDMA, WLAN, bluetooth or other wireless antennas. The control module in FIG. 5 controls all of the antenna modules. The implement method of the mobile station module is carried out using a software radio technology. The method is implemented by using a dynamic radiation code of a physical layer of the software radio and a tunable front-end. The software-radio based mobile station can be applied in a mixed network to handover in each network.

The mobile station can detect the communication quality of each link with the support of the antenna modules, so as to handover among the routers in time.

[2] Data Provided by Link Layer

When the link layer detects that a key parameter (such as SNR) is lower than a threshold value, the link layer sends a handover signal to the network layer and provides related parameters of the link layer at the same time. If the WLAN is switched to the CDMA, the network provides the network ID. An implementation function is defined as follows. Parameters of the function are variable, and these parameters come from the control module of the antenna modules.

Function: the reference symbols “L2” and “L3” show “handoverParameterProvide” (LinkP1 n1, LinkP2 n2, LinkP3 n3, . . . ).

[3] Determination by Network Layer

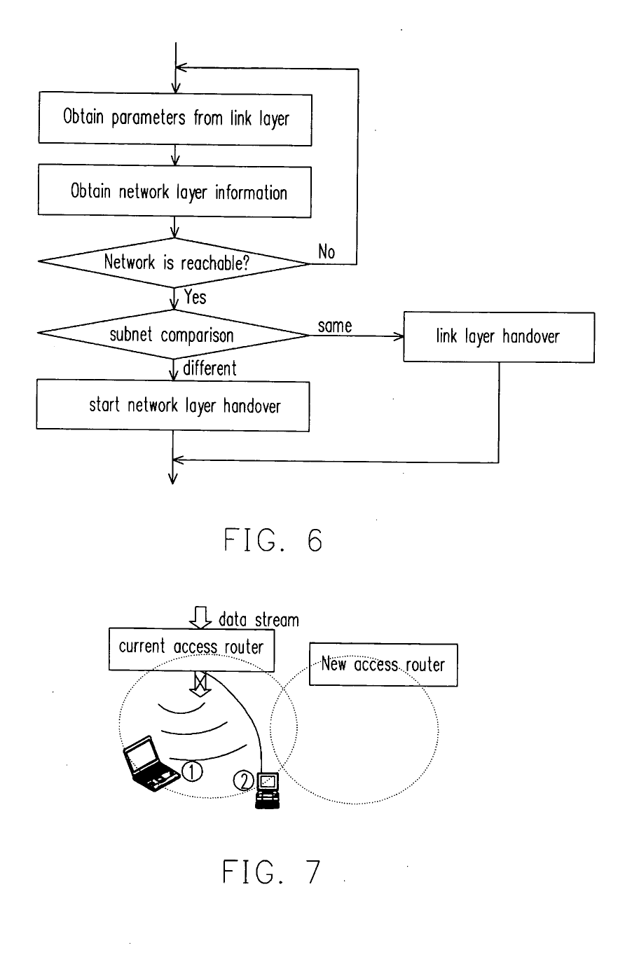

According to the parameters obtained from the link layer, the network is tested. The mobile station sends a request to the current router. The current router is queried in the IPv6 network according to the mobile station information, and returns network information of a new router to the mobile station. Since the link layer handover does not always lead the network layer handover, it is not necessary to process the handover at the router. For example, the handover of the mobile station between different access points in the same WLAN subnets does not need the network layer. The mobile station compares the received new network address with the current network address. If there are reliable different networks, the third layer handover starts. If reliable but the same network exists, the network layer handover is not processed and only the link layer handover is performed. FIG. 6 is a flow chart of this process.

Since the communication quality of the link layer is monitored in time and a reliable new access link is selected, the network layer handover starts and finishes before the current communication is offline. Therefore, the handover interrupt time can be reduced. The process of the network layer handover will be described in detail below.

2. Pre-CoA Preparation

The pre-CoA is mainly used for uncontrollable handover, and the CoA of the mobile station during the controllable handover is easily obtained. Of course, it is very difficult to determine whether a certain handover is a controllable handover or an uncontrollable handover. Therefore, the mobile station always keeps the pre-CoA.

Since the mobile station has a connectable router table and a connectable network prefix table in the Mobile IPv6, a pre-CoA table can be obtained by using the two tables. According to the network prefix, the mobile station can use a dynamic or a static address generating method to obtain a pre-CoA. TABLE 1 shows three tables of the mobile station. The currently added is a pre-CoA table.

TABLE 1

| prefix table | pre-CoA table | Router list |
|---|---|---|
| 3ffe:327d:100:1/64 | 3ffe:327d:100:1::6 | 3ffe:327d:100:1::1 |
| 3ffe:327d:200:1/64 | 3ffe:327d:200:1::10 | 3ffe:327d:100:1::1 |
| . . . | . . . | . . . |

3. Position Update to Home Agent

When a new CoA is confirmed, the mobile station performs a position registration to the home agent. In the position registration information, “N” bit position represents that this message is position registration information of the mobile station and contains communication end information of the mobile station. The “N” bit as shown in FIG. 3 is a reserved field for a mobile IPv6 binding message.

The binding message (BU) of the mobile IPv6 is used for the position update of a standard mobile IPv6. The present invention utilizes its reserved field to implement special functions of the present invention. In order to guarantee the safety of the binding message, the home address (HoA) of the mobile station is written into information and an IPsec function can be applied.

When the home agent receives the position update information of the mobile station, the home agent sends a position update message to the communication end of the mobile station. In order to perform a smooth handover, the mobile station still uses its original CoA at the same time until the original CoA is abandoned.

Since the home agent only manages the position information of the mobile station during the entire handover process, no large amount of data encapsulation and forward is performed. The overhead problem of the home agent can be solved.

4. New Function module of Communication End

In order to establish a direct link to the mobile station, the position alternation to the mobile station is completed between the communication end and the home agent. After the home agent receives information that is sent to the mobile station when the communication end establishes the communication, the home agent returns the current CoA of the mobile station. After the home agent receives the position update information sent from the mobile station, the home agent also sends the position update information of the mobile station to the communication end, as shown in FIG. 2. The overhead problem of the home agent can be solved.

FIG. 1 illustrates the handover procedure. The procedure is that: (1) the mobile station sends a handover request signal (router solicitation for proxy, a short information packet sending from the mobile station to the current access router, used for informing the current access router of the mobile station starting the handover) to the current access router (oAR); (2) the current access router sends a request signal (handover initiate, a short information packet sending from the current access router to the new access router, used for informing the new access router of handover information of the mobile station) to a new router; (3) the current access router sends a handover acknowledge signal (handover acknowledge, an acknowledge short information packet for successfully accepted handover request of the mobile station, sending from the current router to the mobile station) to the mobile station; (4) the new router sends network information (handover acknowledge, an acknowledge short information packet for handover information contained, sending from the new router to the current router to the current access router; (5) the current router returns network information of the new router to the mobile station; (6) the mobile station binds the received new information and then sends it to the home agent; (7) the home agent sends binding acknowledge information to the mobile station; and (8) the home agent sends the position update information of the mobile station to the communication end.

FIG. 2 illustrates the handover procedure in a information flow manner. The handover procedure in FIG. 2 is controllable. The solution for uncontrollable handover case is shown in FIG. 4. Namely, after the mobile station is connected to the new router, the standard mobile IPv6 handover starts. However, time for waiting to obtain a new CoA can be saved because of the CoA cache. Therefore, the handover time for the uncontrollable handover can be reduced.

5. Handover Situation Analysis

As shown in FIG. 7, the mobile station can use (1) a wired way or (2) a wireless way to be connected to the current router (oAR), thereby covering such a region of the new router that the mobile station can move. If connected in the wired way, the current router will immediately discover that the mobile station is not in this region, and then take corresponding actions. But, in the wireless connection case, the current router does not know that the mobile station is not in this region, and still transmits data in a wireless radio way, so that a large amount of data will be lost.

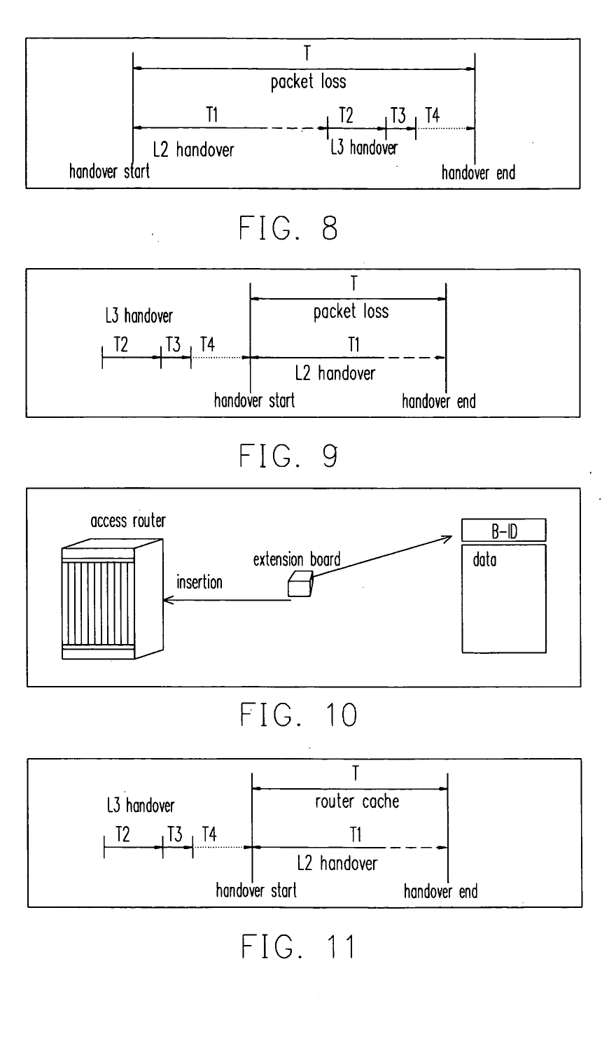

FIG. 8 is a schematic time diagram of the mobile IPv6. A handover time of the link layer L2 and a handover time of the network layer L3 are included. The reference symbol “T1” represents the handover time of the link layer. T1 occupies a large portion of the entire handover time. In this time period, the mobile station cannot receive and transmit data. The reference symbol “T2” represents a time of discovering a new router and a new network prefix, and is a very small portion as compared with T1. But, T2 occupies almost half of the entire network layer handover time. In this time period, the mobile station can send and receive some control information, but cannot send and receive data. The reference symbol “T3” represents a time of forming a new CoA. Since this step is finished by the mobile station itself, this time period is very short. The reference symbol “T4” represents a position update time of the home agent and the communication end. T4 is represented by the broken line since the distance from the home agent and the communication end to the mobile station can be two sides of the earth, or just two neighbor machines.

Therefore, the total handover time “T” is a sum of T1, T2, T3 and T4, i.e., T=T1+T2+T3+T4.

The present invention divides the handover into two categories, controllable and uncontrollable categories. In the widely used communication systems, GSM and CDMA, most handovers are controllable. Generally speaking, the controllable and uncontrollable cases have the following ratio:
Controllable case: 75%; and
Uncontrollable case: 25%.

The present invention should be a controllable system, but the occurrence of the uncontrollable case is not excluded. Therefore, the present invention also provides solutions for the uncontrollable case, as shown in FIG. 4. But, the uncontrollable solutions are only supplements of the entire solution.

The mobile station uses intelligent antenna modules to select communication channels, having a handover procedure as shown in FIG. 9.

Here, there is used the technology that the network layer handover is finished before the link layer handover is finished. The total handover time is T=T1. Theoretically, if the link layer technology is good enough, T1 can be 0 and then the total handover time will be 0, so that the packet loss number is L=T*S. The reference symbol “S” represents a communication speed. If T is 0, L will be 0. The current measured result is T=8s. Therefore, the present invention proposes the solution that data is cached by the new router in this period of time.

6. Router Cache

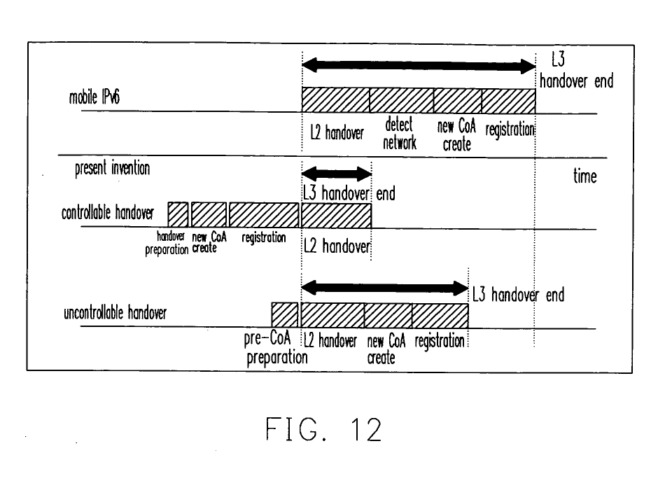

As shown in FIG. 10, a new module is added to the access router. Therefore, datagram during the link layer handover procedure is cached, and then the packet loss caused by the handover is reduced.

A special route is added to the router table of the router. The output address of the route is directed to an extension board. Data forwarded to the mobile station is cached in time period T1. The extension board is a storage device, and is used to store data of the mobile station according to the mobile station identification (B-ID). When the mobile station and the router establish a connection, the stored data is immediately forwarded to the mobile station. This mechanism avoids data loss in the time period T1. The entire handover procedure becomes a procedure shown in FIG. 11.

It is possible to reduce greatly the packet loss rate since the router caches data during the interrupt time.

1. A seamless handover method for a mobile IPv6 home agent, comprising the steps of:
finishing a network layer handover of a mobile IPv6 before a mobile station finishes a network layer handover;
performing a position management to the mobile station by the home agent;
sending update information having communication end information to the home agent by the mobile station, and substituting the mobile station for the home agent to finish a binding update of the communication end.

2. The seamless handover method for a mobile IPv6 home agent according to claim 1,
wherein the mobile station has a pre-CoA (care-of address) cache that can be applied to a uncontrollable handover case.

3. The seamless handover method for a mobile IPv6 home agent according to claim 1 or 2,
wherein a new access router caches data sent to the mobile station during the link layer handover procedure so as to reduce a packet loss.

4. The seamless handover method for a mobile IPv6 home agent according to claim 1,
wherein, when the communication end communicates with the mobile station, a position query of the mobile station is performed to the home agent and after a current care-of address of the mobile station is obtained, a link for directly communicating with the mobile station is established.

5. The seamless handover method for a mobile IPv6 home agent according to claim 1 or 4,
wherein a reserved field of a binding message of the mobile IPv6 is applied to the entire network.

6. A seamless handover method for a mobile IPv6 home agent, comprising the steps of:
sending a handover solicitation signal to a current access router by a mobile station;
sending a solicitation signal to a new router by the current access router;
sending a handover acknowledge signal to the mobile station by the current access router;
sending network information to the current access router by the new router;
returning the network information of the new router to the mobile station by the current accessing router;
sending a received new message to the home agent by the mobile station;
sending binding acknowledge information to the mobile station by the home agent; and
the home agent sending position update information of the mobile station to the communication end,
wherein after the eight steps are finished, the entire handover procedure ends and, otherwise, an ordinary mobile IPv6 handover procedure is performed.

7. The seamless handover method for a mobile IPv6 home agent according to claim 1 or 6,
wherein the mobile station has a single or multimode access channels to monitor link information of each channel of 3G, CDMA and WLAN.
